(19) United States
(12) Patent Application Publication
(10) Pub. No.: US 2010/0023416 A1
(43) Pub. Date: Jan. 28, 2010

(54) BUSINESS PORTAL

(76) Inventor: Lee Floyd, Atlanta, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/299,661

(22) PCT Filed: May 31, 2007
(86) PCT No.: PCT/US07/13079

§ 371 Date: Feb. 26, 2009

Related U.S. Application Data
(60) Provisional application No. 60/803,605, filed on May 31, 2006.

(51) Int. Cl. G06Q 99/00; G06Q 30/00; G06Q 40/00; G06F 9/445

(52) U.S. Cl. 705/26; 705/1; 705/35; 717/178

(57) ABSTRACT

A business portal for the exchange of resources is described. A method of transacting resources may include establishing a forum to transfer resources from a resource provider to a resource seeker, implementing a resource provider rule, implementing a resource seeker rule, identifying a user of the online forum as either a resource provider or a resource seeker, and associating the resource provider rule with the user if the user is identified as a resource provider or associate the resource seeker rule if the user is identified as a resource seeker. The transaction of resources may occur either wholly in the portal or a portion of the transaction may occur in the portal and a portion may occur through the use of a software package. The resources may include a service, funding for a business, an investment, information relating to a topic, or the facilitation of the exchange of a resource.

### CROSS-REFERENCE TO RELATED APPLICATIONS

This application claims priority to U.S. Provisional Application No. 60/803,605 filed May 31, 2006. The complete disclosure of this prior application is hereby incorporated herein by reference in its entirety for all purposes.

### BACKGROUND

In the present day, access to resources such as investment opportunities, information, services, etc. is quickly becoming ubiquitous. Resource providers, such as those with money to invest, and those needing the resource are increasingly connected to the same platform of communication, the internet. Because of the ease, low cost, and relative anonymity of the internet, the internet is becoming saturated with both legitimate and non-legitimate resource providers. In part, due to the shear numbers of participants and users of the internet, distinguishing between legitimate and illegitimate resource providers and those needing resources may have become unwieldy.

Because the use of the internet has increased among the population and is quickly supplanting traditional forms of communication, an ever-increasing percentage of the population, those without the business connections or those without the skills to effectively navigate the internet, may be unable or unwilling to participate. It may be difficult for those individuals that already have a sense of apprehension about interfacing with a new form of communication medium, i.e. the internet, to go one step further and interact with others and use the medium for personal or business reasons.

Resource providers and those needing resources may feel wary about exchanging resources through the website, especially one involving the exchange of money. Security breakdowns are increasing across the internet. Internet websites may sell user information garnered through the website to develop a new income stream. It is not uncommon for a user who purchases an item from an online site to instantaneous start receiving spam related to that purchase from unknown, and potentially malicious, sources. Additionally, there are regular reports about security breaches, allowing third party access to highly sensitive personal information.

Some internet websites currently attempt to alleviate the above issues by essentially acting as a watchdog over the content and users of the website through the use of barriers. The most basic of barriers is perhaps the “Terms of Use” for the website. If a person wishes to use the website, the website owner may require the user to accept the Terms of Service before being allowed to interact with the website. Another barrier may be user ratings of other users. The rating may be based upon user surveys or input of other users. That way, users have an opportunity to see how a particular user is viewed in the website community.

There are shortcomings to the present way of protecting users. First, not all users of the website are the same. A resource provider would likely interact with the website in a different manner than those searching for resources. The level of sophistication, the desired and necessary, information to fully interact with other users, may be different between a resource provider and a resource searcher. Rules set into place that may be beneficial to one type of user may be unworkable or harmful to another user. Second, barriers commonly used are just that, barriers to use. If a user is already unfamiliar with using a website, placing additional barriers up to usage may become unacceptable.

### SUMMARY

A business portal is provided that facilitates interaction between resource providers and resource seekers. In one non-limiting example, a method of facilitating the exchange of resources is described, the method comprising the steps of establishing an online forum to exchange information related to resources, implement a first rule of using the online forum for a resource provider, implement a second rule of using the online forum for a resource seeker, identify a user of the online forum as either a resource provider or a resource seeker, and associate the first rule with the user if the user is identified as a resource provider or associate the second rule if the user is identified as a resource seeker.

In another non-limiting example, a method of facilitating the exchange of resources is described, the method comprising the steps of establishing an online forum to exchange information related to the resources, facilitate the generation of a resource transaction from a resource provider to a resource seeker, facilitate a first portion of the resource transaction in the online forum, and facilitate a second portion of the resource transaction outside of the online forum.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, these embodiments are not limited to the specific methods and instrumentalities disclosed. In the drawings:

FIG. 1 is a diagram illustrating a forum, or portal, for the exchange of resources;

FIG. 2 is a diagram illustrating access to a forum for the exchange of resources;

FIG. 2a is a flowchart illustrating an exemplary and non-limiting way to interface with a portal for the exchange of resources;

FIG. 3 is a flowchart illustrating an exemplary and non-limiting way to find investments;

FIG. 4 is a flowchart illustrating an exemplary and non-limiting way to find investors;

FIG. 5 is a flowchart illustrating an exemplary and non-limiting way to provide software for the completion of a portion of a resource exchange;

FIG. 6 is a flowchart illustrating an exemplary and non-limiting way to build, refine, and access a knowledge database;

FIG. 7 is a flowchart illustrating an exemplary and non-limiting way to fund business projects; and

FIG. 8 is a flowchart illustrating an exemplary and non-limiting way to provide services or goods.

### DETAILED DESCRIPTION

The subject matter of the described embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. Finally, the communication configuration between computing resources in the following figures are meant to be only illustrative.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed embodiments. In the case of program code execution on programmable computers, the computer will generally include a processor, a storage medium readable by the processor (including volatile and non-volatile memory and/or storage elements), at least one input device, and at least one output device. One or more programs are preferably implemented in a high-level procedural or object-oriented programming language to communicate with a computer system. However, the program(s) can be implemented in assembly or machine language, if desired. In any case, the language may be a compiled or interpreted language and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder, or the like, the machine becomes an apparatus for practicing the present disclosure. When implemented on a general-purpose processor, the program code combines with the processor to provide a unique apparatus that operates to perform the processing of the disclosed embodiments.

As referred to above, the exchange of resources such as knowledge, business contacts or investments, on an online forum such as the internet has become difficult to manage and control, and more importantly, to use effectively. There are an ever-growing number of users that have malicious intentions, either as phony resource providers or resource seekers. The ultimate goals for these fraudulent users are either to obtain enough personal information to steal another user's identity, or, to lead the other user into believing a legitimate exchange is taking place so that funds are deposited into an account. Once the user that deposited the funds finds out that the exchange was fraudulent, it is usually too late to retrieve the funds, as they have likely been removed without any trace.

The present disclosure may be used to develop a virtual community to improve the process of starting a business. Small businesses are the backbone of most economies around the world. In most countries these small businesses are also the primary employers locally and nationally. Small businesses are also where most of private sectors innovative ideas spring from due to there ability to identify with local consumer's needs and potential changes in consumer's demands. Despite these benefits to the overall economic welfare of our country, small businesses concerns, including the assistance to help individuals create and maintain small businesses, are typically not a major economic concern.

People who've tried to develop small businesses often encounter many different problems (support, information, or funding) that seriously inhibit their ability to create the business and, in a large number, stop their “entrepreneurial spirit.” Even with all the modern tools like the Internet, people developing small business have been blocked by comprehension barriers due to social problems, commonly termed the Digital Divide, Economic Divide, the Middle Class Squeeze, or the lack of Economic Mobility. In the last few years, the Internet began developing communities designed to help people communicate with each other for all sorts of reasons. These online communities have proven effective in reduce comprehension barriers and communication problems.

In addition to assisting individuals create and maintain their business, the present subject matter may also be used to create a business tool that simplifies the structuring of a business to find potential business partners. Learning how to structure a small business is may be as important as understanding the industry, understanding the competition, or understanding how to make money. Many small businesses fail because of poor structure. A large number of businesses are structured improperly due to lack of assistance at a company's early stages of development, timely professional advice during development, and improper personnel decisions. With the assistance of the local community, a potential business owner may use the present subject matter to find people to help them earlier in the company's lifecycle. In addition to other benefits, the present disclosure may give business owners the ability to use the business portal and, with the use of supplemental software as needed, assist the prospective business owner to structure their company for, among others, potential business partners, micro investors, and resource providers.

The present disclosure may also be used to develop a local business marketing platform that improves hit results by adding more related business with improved advertising content. As new small businesses begin to develop within local communities, they will need a platform to advertise their goods or services. We know there are multiple methods available to business owners to market their companies to the public. However, most of these platforms available to business owners are very expensive and lack content flexibility. We have developed a new virtual platform that will allow business owners to have to visual impact of a TV commercial, the content availability of a website, with a local presence of a phonebook! We can also offer this new platform for a fraction of the cost of TV, Phonebook, or Search Engine advertising! Plus business owners will be able to create content with their own consumer bought equipment. This is what we call Homebrew Advertising.

Additionally, the present subject matter may also be used to create a better method for resource providers and resource seekers to interact within a community driving by user content. Even if two users are legitimate, the shear numbers of users interacting in the forums available online often make it difficult to effectively interact with the website. For example, a user with little to no experience in financial matters may be inundated with a number of websites that provide financial information, and may be further inundated with the amount of information available on the website. Thus, even if the inexperienced user were successful in finding an online forum, the user may still have to figure out how to sort through a potentially vast amount of information, and be ready to spend the time doing so.

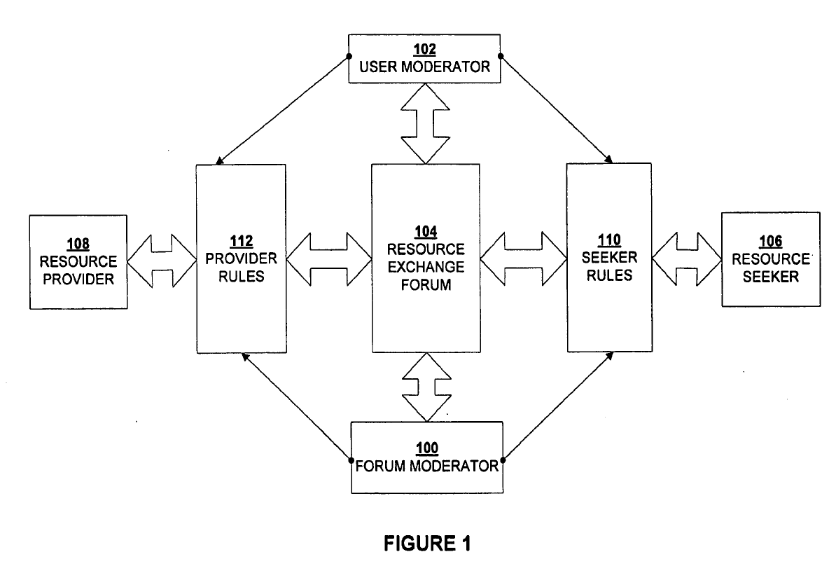

FIG. 1 illustrates a forum for the exchange of resources. Resource exchange forum 104 is established to assist in communication between users such as resource provider 108 and resource seeker 106. The present disclosure is not limited to any particular type of user, including resource provider 108 or resource seeker 106, as other users may access forum 104, such as those browsing the website. Further, resource provider 108 and resource seeker 106 are defined according to the manner in which they interact with the forum. For example, a user that is seeking resources in one instance may be a resource provider in another instance. Additionally, although not limited to any particular type of forum, an exemplary and non-limiting example of forum 104 may be an online website. A website may provide certain advantages such as access from most locations as well as the ability to structure forum 104 to meet the needs of the users.

After forum 104 is established, forum moderator 100 establishes provider rules 112 and seeker rules 110 to control the manner in which resource seeker 106 and resource provider 108 may interact with other users and forum 104. Rules 110 and 112 may incorporate several manners of controlling and facilitating the interaction of seeker 106 or provider 108 with forum 104, examples of which may be basic login information required, terms of use, information allowed to be accessed or provided, limitations on the use of forum 104, and others. Rules 110 and 112 are preferably not limiting in the manner that the ability to interact is necessarily limited. Rather, rules 110 and 112 are preferably intended and designed to facilitate the interaction between users.

For example, provider rule 112 may be established so that in order for resource provider 108 to invest in businesses owned by resource seeker 106, resource provider may be required to provide prior year tax returns as well as provide additional information such as current economic status and net worth. Thus, provider rule 112 may act as one layer of validation. Further, seeker rule 110 may also require tax returns from the business, sales information, and ownership information for resource seeker 106 to use forum 104 to possibly interact with resource provider 108. In this manner, rules 110 and 112 partially provide a level of assurance to resource seeker 106 and resource provider 108 that their interaction is more than likely legitimate, thus opening the communication pathway and allowing a freer exchange of resources and information related to those resources.

As resource provider 108 and resource seeker 106 may be two different types of users interacting with forum 104 for different purposes, the manner in which they interact with and the information they need may be different. Thus, as with the current example, rules 110 and 112 are different. In another example, if the resource is knowledge, a resource seeker may be searching for knowledge about a particular subject and a resource provider may be providing knowledge about a particular subject. The manner in which the seeker and provider interact with the forum will thus be different.

Further, rules 110 and 112 may be different because the impact upon the forum may also be different. For example, a provider may maliciously input erroneous knowledge into a knowledge database, or knowledge store, accessible by multiple resource seekers. Thus, one resource provider may affect a significant number of resource seekers. Thus, because the interaction is different, rules directed to the manner in which resource provider 108 interacts with forum 104, provider rules 112, and rules directed to the manner in which resource seeker 106 interacts with forum 104, seeker rules 110, are preferably different.

Although forum moderator 100 may be provided with the authority to establish and implement provider rules 112 and seeker rules 110, it may be preferable to allow users of forum 104 to modify rules 110 and 112. One reason to allow users of forum 104 to modify rules 110 and 112 would be to reduce the administrative cost of moderating and controlling forum 104. If forum 104 has a significant number of users and a significant number of resource exchanges occurring, the cost to monitor and control each instance of interaction may be economically cumbersome. Thus, in one embodiment, the users of forum 104 may be allowed to modify rules 110 and 112.

The modification of rules 110 and 112 may not only be directed to resource seeker 106 or resource provider 108 generally, but rather, may also be directed to an individual resource seeker or an individual resource provider. For example, if resource provider 108 continually contributes wrong or slightly erroneous knowledge to a knowledge database, user moderator 102 may posit to forum 104 that the ability of resource provider 108 to submit knowledge be limited or restricted. User moderator 102 is not defined to be any particular user, but rather, is defined as a user performing a moderating function. In other words, resource seeker 106, resource provider 108, or any other user when modifying rules 110 or 112 may be considered to be user moderator 102.

There may be several ways to allow the modification of rules, but one way may be to provide a rating system to provide the ability of a user to rate resource provider 108 low enough to restrict the abilities of resource provider 108. In the same manner that rule 112 for resource provider 108 may be modified by user moderator 102, or forum moderator 100, seeker rules 110 may also be modified by user moderator 102 or forum moderator 100. Resource seeker that is determined not to be interacting with forum 104 in a proper manner may be subjected to constraints by modifying seeker rules 110.

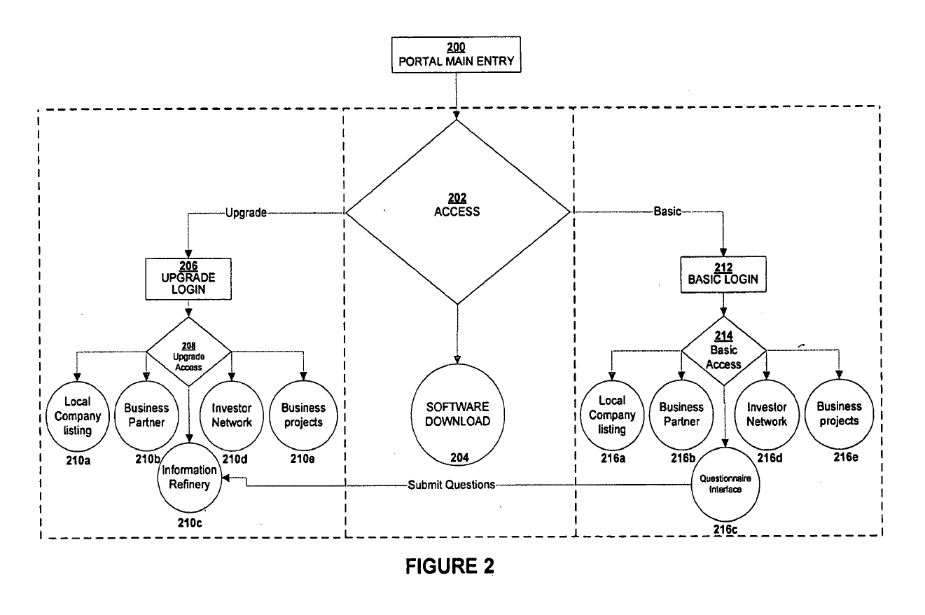

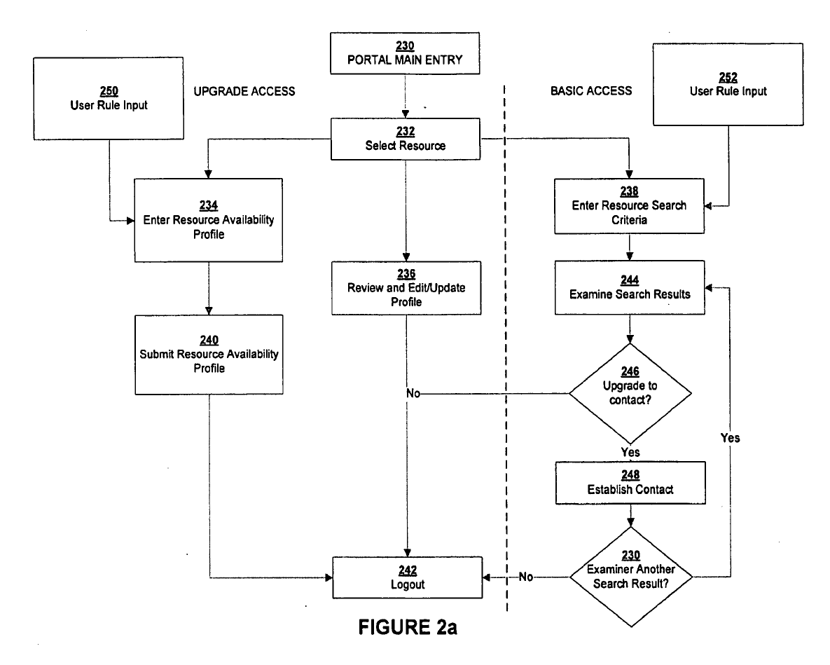

FIG. 2 is an exemplary and non-limiting example of a system showing various resources and various access levels for a forum as described by example in FIG. 1 above. Shown in FIG. 2 is portal main entry 200. Portal and forum are used herein interchangeably. A user will preferably first be presented with entry 200 prior to accessing the contents of the portal. If a user wishes to access the contents of the portal, the user will then be presented with access 202, which depending upon the login information provided by the user, will either connect to upgrade login 206 or basic login 212. In the same manner that resource seekers and resources providers may interact with the forum differently, users in general may interact with the forum different. A resource seeker may only want access to certain information while another resource seeker may want access to that information plus additional information. Therefore, in this example, basic login 212, or subscription, would provide access to some level of information whereas upgrade login 206 would provide access to additional information.

Another possible destination stemming from access 202 may be software download 205. Users of the forum may be presented with access, outside of basic login 212 or upgrade login 206, to downloadable software. Software may be made available to the users of the forum to help, among other things, facilitate a resource transaction. In one exemplary and non-limiting example, if the resource is money to be exchanged from a resource provider to a resource seeker, the two users may establish a portion of the exchange in the forum and complete the other portion of the exchange through the use of the software. The first portion may be the exchange of identification as well as business projections, whereas the second portion may be the exchange of money out of a bank account to another bank account.

After logging into the portal either via basic login 212 or upgrade login 206, the user is presented with either upgrade access 208 if logging into via upgrade login 206 or basic access 214 if logging in via basic login 212. Access 208 and access 214 are entry points that may display several resources available to the user. These resources may include local company listing 210a,216a, business partner 210b,216b, investor network 210d,216d, and business projects 210e,216e. These resources are exemplary only, as other resources are considered within the scope of the present disclosure. The level of access to each of these resources depends upon which login was used, i.e. basic login 212 or upgrade login 206.

Another resource for use is knowledge. Shown in FIG. 2 are information refinery 210c and questionnaire interface 216c. Information refinery 210c and questionnaire interface 216c are related in that both are sources of information. As previously mentioned, a user logging in via basic login 212 has a lower level of access to resources than a user logging in via upgrade login 206. The user may be limited to only viewing questions and answers via questionnaire interface 216c whereas a user may also view questions and their respective answers, but also send in questions, answer questions, and rate the quality of answers via information refinery 210c.

FIG. 2a illustrates an exemplary and non-limiting way of accessing resources through the portal. The user will first enter the portal at step 230 and select which resource the user wishes to access at step 232. If the user logged in via an upgraded access and wishes to upload the user's profile to be a resource provider, the user will enter profile information at step 234 and submit that information at step 240. The upgraded user may also review and edit previously entered profile information at step 236. The upgraded user, as well as those users that log in via a basic access level, may also wish to search for resources, thus interfacing with the portal as a resource seeker. As discussed above, it is preferable that a user with upgrade access be provided with the ability to interface fully with the portal, that is, the upgrade user will preferably have access to all the features and capabilities of the basic user as well as upgraded capabilities such as the ability to upload a profile to be searched as well as review and edit that profile. When discussing features available in a basic access, it is preferable that those features may also be available to those with upgraded access.

Therefore, at step 238, the user with a basic access level may enter profile search criteria relating to the resource and examine the search results, if any, at step 244. If the user, after examining the search results, wishes to contact the user at step 246 associated with the profile of interest, the user may be provided at step 248 with contact information. If the user does not have an upgraded access, the user may continue searching at step 230, upgrade to contact at step 248 or logout of the resource portal at step 242.

A resource seeker and resource user may interact with the portal in different ways because, inherently, their goals may be different. Because of the different purpose and intent of interacting with the portal, the way in which the resource seeker and provider are allowed to interact, and the manner in which they interact, would preferably also be different. In one exemplary and non-limiting example, a moderator of the portal may establish certain basic guidelines, or rules, by which a user may sign up to be a user of the portal. A user seeking resources may be required to provide certain identification information as well as accept the portal's terms of service. A user providing resources may be required to provide additional identification information as well as provide support for their ability to be a resource provider. For example, if a user wishes to invest money, i.e. the resource is investment funds, the resource provider may be required to provide, among other things, tax returns, educational background, economic status, etc. Confidential information will likely be protected and secured according to industry standards.

Members may also modify or amend the rules in which a user accesses the portal. For example, the users may wish to inform the portal and other users that a resource provider rarely returns a contact request from a viable resource seeker. Thus, the users may amend the rules so that when the resource provider is identified in a search request, the resource provider's contact return rate is indicated. Additionally, the users may want to identify and, potentially, block certain resource providers because of past conduct. Therefore, at step 250, the users may provide input to the resource provider's profile that will affect the search results of the resource seeker.

In a similar manner, the users may also wish to amend the manner in which certain resource seekers may interface with the portal, or perhaps, the way in which all resource seekers interface. For example, a resource provider may wish that only resource seekers with currently operating businesses that are operating profitably be allowed to find the resource provider during a search. In another example, a group of resource providers may limit or change the required information for resource seekers based upon a particular industry's best practices. For example, investors in a particular industry may need certain information prior to making an investment decision. While certain basic information may never change, other information necessary to make an informed decision may vary from time to time. For example, in the computer industry, certain fields of endeavor may have more potential profitability, while other fields may be waning in potential. Thus, at step 252, users may amend the rules by which a resource seeker interfaces with the portal.

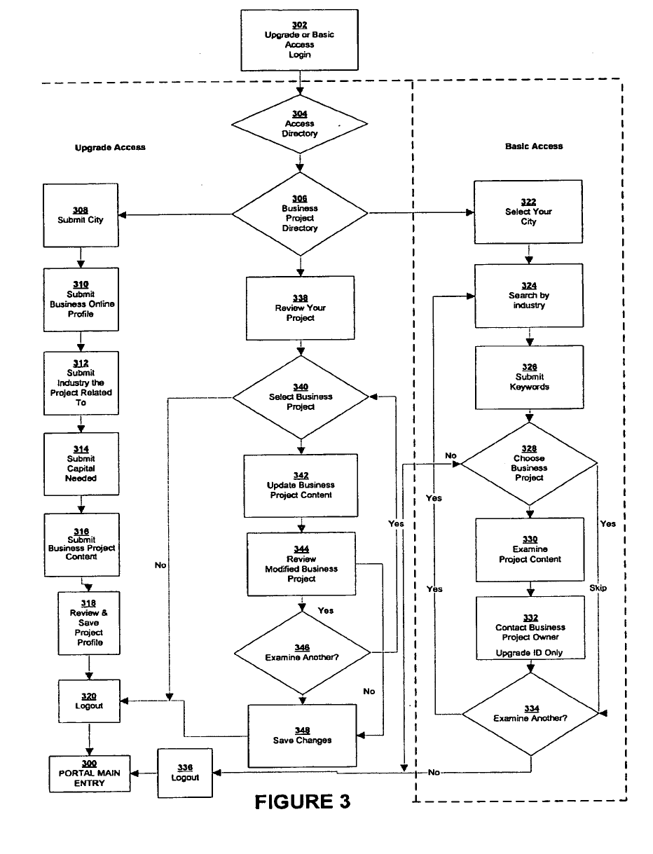

Various resources may be provided in the manner described with regards to FIG. 2a. FIG. 3 illustrates an exemplary and non-limiting way to access business project resources. Business project resources are the submission of or search for business projects for the potential of finding an investor or investing their own money. The user first logs in at step 302 either in an upgrade or basic access. Once the user logs in, at step 304, the user is presented with an access directory. The access directory is preferably a listing of available resources, including either the submission or review of a business project. At step 306, the user is presented with the business project directory. If the user logged in via a basic access login, the user is directed to step 322, wherein the user selects their city. The city may be the user's city or another city in which the user wishes to focus their search on. There may be a myriad of ways in which to focus a search for business projects. A typical user, especially one that is not highly experienced in finding and potentially investing in business projects, may feel more comfortable focusing their search in the area in which they live.

After the basic user enters their city information, the user will search by industry at step 324. The industry may be any type of industry, such as technology, restaurant, etc. To further refine the search, the user may, at step 326, submit keywords to perform a keyword search within the city or industry. The user may also perform searches without first entering the city or industry. Once the user enters the search parameters, the results return a listing of business projects. At step 328, the user selects a business project to review at step 330. If the business project is interesting to the user, the user may contact the business owner to discuss further at step 332. It may be preferable to only provide contact information to those that upgrade their access as a source of revenue. After examining the business project content, the user may wish to examiner another project at step 334. If the user does not wish to examiner another project, the user logs out of the business project portal at step 336 and returns to the portal main entry page at step 300.

In the upgrade access, the upgrade user may also wish to search for business projects, but also may wish to find investors in a business project. At step 308, the user submits city information regarding the location of the business project. The user, at step 310, then submits a business profile online. A business profile may be a summary of the business. After submitting the business profile, at step 312 the user submits the related industry and at step 314 submits the capital needed. Once the capital is submitted, the user may submit the content of the business project at step 316 and be provided an opportunity to review and save the project at step 318. Once completed, the user may log out at step 320 and be returned to main portal at step 300.

In addition to uploading a business project to find potential investors, the upgraded user may also search for business projects in the same manner as the basic user and may also modify the business project submitted. For example, at step 338, the user may review their previously submitted project, select a business project at step 340, update the content at step 342 and review the updated business project at step 344. At step 346, if the user desired to modify another business project, the user is returned to step 340, else the user saves all changes at step 348 and logs out at step 320.

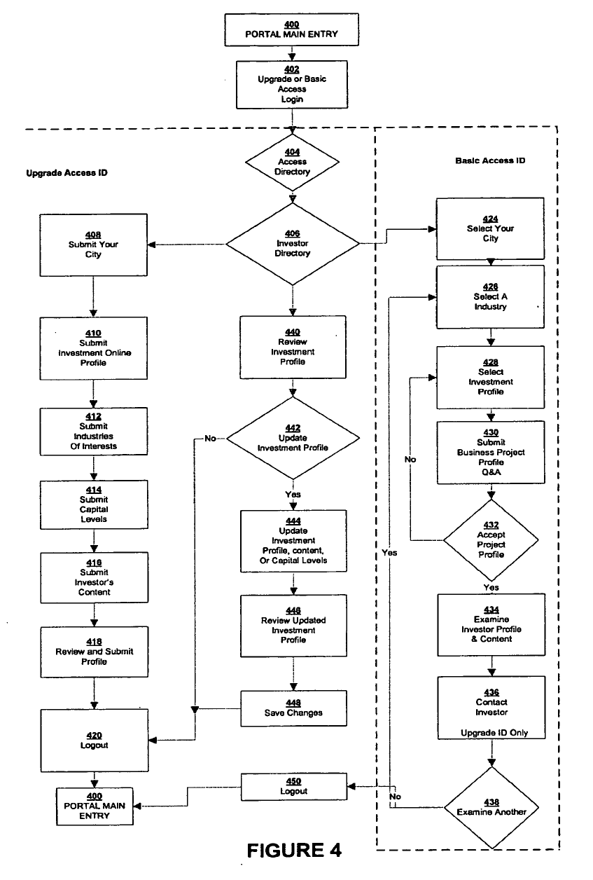

FIG. 4 illustrates further the resource of finding investors and providing the investor resource. The user will login via steps 400-404 to access investor directory 406. At this point, if the user logged in via an upgrade access and wishes to have other users contact them for possible investments, the user will submit their city at step 408, their investment profile at step 410, industries of interest at step 412 and their capital levels at step 414. These and the following steps help searchers to find relevant investors. At step 416, the investor will submit their content. The content may include tax returns, bank account statements and other economic information. It may be preferable to protect that information to prevent unwarranted access. Once the content is submitted, at step 418 the user reviews the profile and submits it then logs off at step 420. The user is then returned to portal main page at step 400.

The investor may also wish to review their investment profile at step 440, and after review, if the user finds it acceptable at step 442 will logout at step 420. If the user wishes to amend their profile, at step 444, the user may update their investment profile, content, or capital levels. At step 446, the user may review their updated investment profile and save changes at step 448, and thereafter, logout at step 420.

If the user accesses the portal via a basic login, the user may wish to search for investors by selecting their city at step 424, an industry at step 426, and investment portfolio at step 428. At step 430, the user will submit a business profile project Question and Answer form that will assist in searching for a viable or suitable investor based upon the investor's inputted information. If the users profile Q&A is not acceptable, then the user will be returned to either resubmit the industry or profile at steps 426 or 428, respectively. If the users Q&A is accepted, the user will examiner the returned investor profile at step 434 and have the option of contacting the investor at step 436 if the access is upgraded. At step 438, the user may examine another investor profile or logout at step 450.

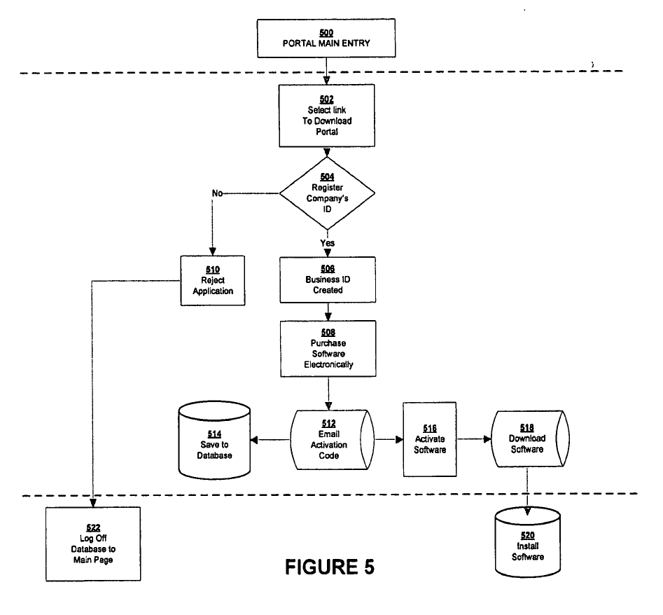

If the a user seeking an investment and a user approving an investment wish to exchange resources, e.g. money for shares of a company, the users may wish to interact outside of the forum yet still use the framework provided by the forum to complete the transaction. FIG. 5 illustrates an exemplary and non-limiting way in which a portion of a transaction may be completed using a secondary platform, whereas the initial searching is done in another platform, preferably the forum or portal. An exemplary and non-limiting example of a secondary platform may be software available for download, the software designed to facilitate the transfer of resources from the resource provider to the resource seeker.

At step 500, the user wishing to download the software will log into the portal. It may be preferable to have both users download the software and install on their respective computers. After the user logs into the portal, the user will select a download link at step 502 for the software related to the resource. Because various resources may be available, the transactions of those resources may require different platforms. Therefore, software available for download that provide those platforms may be different.

The following description is related to a business downloading a software package, but the concepts and subject matter also apply to other types of users. The business, at step 504, will register their company's identification. If the business does not wish to register their identification, the download attempt will be rejected at step 510 and the business will be logged off at step 522. There may be several reasons for requiring a business to create a business identification, one of which is to associate the identification of the business in the software download phase with the same business that has been using the portal and contacted an investor. After the business identification is created at step 506, the business will be permitted to purchase the software at step 508. Although not required, the software available to users may be another source of revenue for the portal. The software may also be freeware or another cost structure may be implemented. On the user's system, the user will preferably download the software at step 518 and be emailed an activation code at step 512 before attempting to install the software at step 520. The email activation code will also preferably be stored to a database for future retrieval at step 514. Once the user's software has been activated and downloaded, at step 520, the user will install the software to begin use.

The software may have various functionalities, but will typically provide a mechanism in which to assist the users to exchange resources. For example, the software may include portions to allow the users to submit information about each other without breaking down the confidential barriers until a checking function is completed. The checking function may verify that the information submitted by each user meets certain standards. The checking function may also verify that each user has submitted the information either requested of the other user or a minimal amount of information designated in the software.

Of the various types of resources, the information gathered may be compiled and provided to users at various levels of access. The information database, which may be termed an information refinery, may be a collection of questions and their respective answers as well as articles and helpful information provided by experts in the field, including the ability to access information relevant to the particular user's situation, such as location of the user's business or investment opportunities.

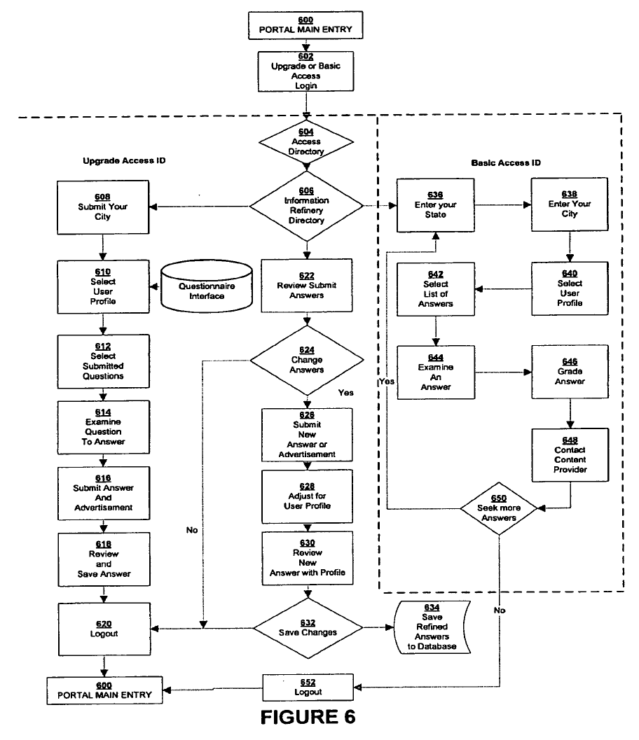

FIG. 6 illustrates an exemplary and non-limiting way of providing information resources to users of the portal. At steps 600 and 602, the user will login to the portal and, from access directory 604, access information refinery directory 606. From the directory, a user having an upgraded access may submit the city relevant to the question at step 608 and select their user profile at step 612. The user, at step 610, may be presented with a questionnaire interface that provides the relevant information necessary as well as a possible listing of questions available for answering.

If the user wishes to answer a question, the user will select a question at step 612, examine the question at step 614 and submit an answer at step 616. The user may also be presented with an opportunity to increase the value of answering questions by submitting an advertisement for their business, if applicable, along with answering the question at step 616. This may have several benefits, one if which is to provide contextual support for the answer provided. The person answering the question that also submits an advertisement may provide the reviewer of the answer not only the answer to the question but additional information as to a business that may provide the services relating to the question. Additionally, it provides another way in which users of the system may monitor the answers provided. If a business has a low overall rating, either within the portal or external sources such as the Better Business Bureau, the answer provided may not be highly regarded and may not be reliable. Once the user submits their answer and provides an advertisement, if desired, the user may review their answer and submit it at step 618 then logout at step 620, after which the user will return to the portal main access page at step 600.

The user may also review their submitted answers and amend them as necessary. One reason the user may wish to amend their answer is to refine the answer based upon responses received from other users. At step 622, the user will review their answers. The users may then change the answers, as desired at step 624 or logout at step 620 if no changes are necessary. If the user wishes to change their answers, the user may do so at step 626. The user may also change their advertisement without changing the answer or in combination with the amendment of answering. The user may wish to do this if the advertisement has changed or to change the advertisement to be more relevant to the question or reviewed responses. After reviewing the amendments at step 620, the user may save their changes at step 632 and logout at step 620. The refined answer is also preferably saved in a database at step 634 for access by other users.

The basic access user may wish to examine and review answers provided. The user will preferably enter their state information at step 636 and city information at step 638. The user will then select their profile at step 640 and a list of answers at step 624. The user may then examine the answer at step 644 and grade the answer at step 646. The grading of answers is one manner in which the users may rate experts and change the rules in which the expert interfaces with the portal. If the user wishes to follow-up with the expert that provided the answer, the user may contact the expert at step 648 and either seek more answers at step 650 or logout of the system at step 652.

A resource may also be for users acting as resource providers to find and fund business projects that are of interest to them. The interface may be designed to facilitate all types of businesses, large or small, or may be focused on either one depending upon the resource providers.

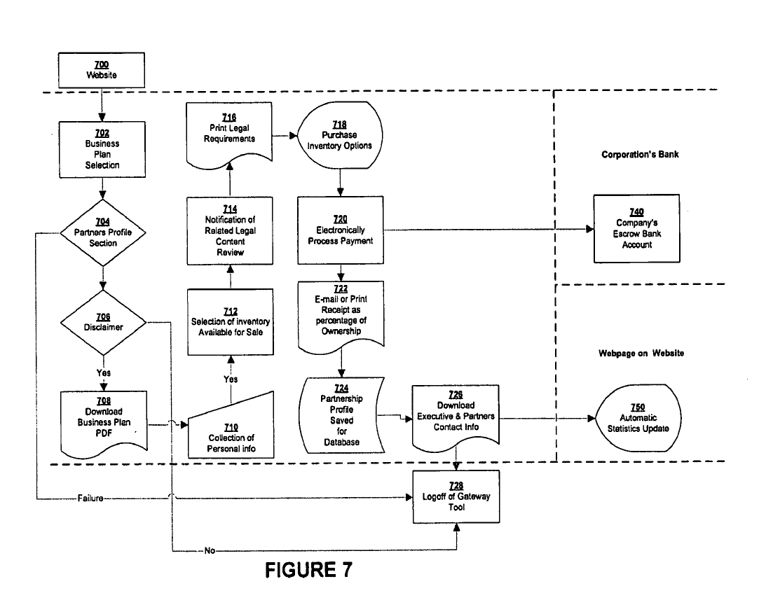

Shown in FIG. 7 is an exemplary and non-limiting example of an investor's gateway interface. At step 700, the resource provider will access the various websites designed by or for business projects. The website may be available either through searching the internet, or preferably, accessible through the integration of the software described above. The business project owner preferably licenses software to create and present content searchable by resource provider.

After the resource provider views various websites, the resource provider may select a business project, or plan, of interest at step 702. The resource provider may select multiple business projects if desired, though the following description is centered on the selection of one business project. After the business project is selected, at step 704, the resource provider will preferably submit their profile, termed a “partner profile”. The profile may have a questionnaire with questions including their investment goals. The questionnaire may be used to determine if the business project selected and the partner profile is an acceptable match, i.e. the goals are similar. The profile may be use to reject the investor if the match is determined to be unacceptable.

If the resource provider is deemed acceptable, a legal disclaimer may be presented at step 706. A disclaimer may include a terms of use which preferably has an option to agree to keep the business project owners information confidential. Upon agreeing to the confidentiality requirement, the full business plan may be downloaded at step 708. The website the resource provider accessed in step 700 may include preferably enough information to describe the business plan without providing confidential information. Basically, the website may be viewed as the “elevator pitch” whereas the business plan may be viewed as the follow-up meeting. If the business project owner wishes the resource provider to provide additional information beyond the profile submitted in step 704, the resource provider may be asked by the business project owner to submit additional information at step 710.

Once the personal information has been submitted, the resource provider may then be permitted to view the inventory of the business project available for sale at step 712. Inventory may vary depending upon the business project owner, but preferably, the inventory is a portion of the company available for sale in either percentage or amount. Because the project ownership amount may be significantly smaller in dollar amounts than a typical investment made over one of the primary or secondary exchange markets, e.g. Dow Jones®, NASDAQ®, the investment may be termed a micro-investment and the investor may be termed a “micro-investor”.

The inventory may be presented in various formats, including pie chart format. After the resource provider, or investor, decided to invest in a portion of the business project or plan, the investor may be provided with, and accept compliance to, legal requirements of the business project at step 714. Preferably, the business project owner will provide the legal requirements. At step 716, the investor may print or download the various legal documents, if applicable. At step 718, the investor may purchase available inventory for purchase, in whatever portions the business project owner has made available. After selecting the investment amount, the exchange of resources proceeds.

At step 720, the investor may select the payment option available to transfer money to the business project owner's bank account. Preferably, the payment will occur in electronic format and the owner's bank account will preferably be an escrow account. This format is preferred to reduce the possibility of fraud. Once the money, or whatever resource is requested, is transferred, at step 722, a receipt of the percentage of ownership is transferred to the investor, either through email or through the regular mail. The partner profile is saved at step 724, indicating the new investment and is downloaded to the business project owner's database for updating on the project website at step 750. Once the resource exchange has been completed, the investor logs out at step 728.

As discussed above, one of the issues with current ways to search for resources is the shear number of possible resource venues that may be available to the user on the internet. If the user wishes to search for a particular business to provide a certain resource, and if a business wishes to be able to directly and efficiently market to the local consumer, internet searches and forums available to put the two in contact may be cumbersome and inaccurate. The alternative may be to use a phonebook or an online phonebook of the area to find the resources. This is the different between retention marketing and direct location marketing.

As the definition implies, retention marketing requires the user to retain some data regarding the information being displayed. The user first must remember the particular search terms used, and further, possible relevant websites either visited or to be visited. Retention marketing is acceptable if the user can retain that data, but for users that require or desire a more formalized approach to searching, direct location marketing is typically used. Direct location marketing is structured in a format to remove all or a significant portion of the information necessary to perform a search. One example may be a phonebook for user's location. The searcher looking for a pizza delivery business will typically turn to the pages for pizza and search through the ads. The searcher can be relatively confident that the pizza business is in the location of interest and will perform the services necessary.

One of the disadvantages of direct location marketing is that the advertisement is typically static, e.g. does not change between publications. Variability is one advantage that retention marketing, e.g. search engine marketing, may have an advantage. With the use of keywords, a consumer can search for businesses. However, even with effective use of keywords, the search may return numerous results that may be inapplicable to the user's search. Keywords are used by search engines to determine the relevancy of a web page to a search request. An entire industry has been created whereas businesses will include certain key terms in their web pages to create an increased number of search result hits.

For a business wishing to serve a local community, they may be forced into either paying additional advertising money to keep their business at the top of a search return list or pay a search engine optimizer to key their search terms for an increased hit rate.

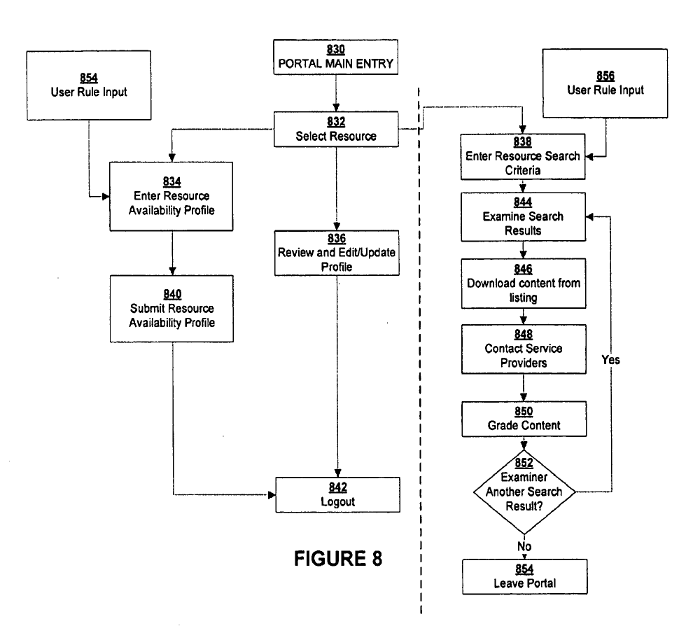

FIG. 8 illustrates an exemplary and non-limiting example of an improved method of searching for businesses and for advertising where the resource is the service provided by the company. At step 830, the user will enter the portal and select a resource at step 832, which for the purpose of FIG. 8, will be either the offering of a service or the search for a service.

If the user is a resource provider, at step 834, the user will enter their profile. The profile will preferably include information such as the location of the business, the language used by the business, and/or the particular industry the business is in. This provides for the ability to create more direct searches and allow businesses to create a more direct approach when trying to target potential customers but reducing or eliminating the possible number of wasted listings. For example, a business may input a profile that it operates in a certain city. A resource seeker may enter into, as part of the search terms, a city of operation. This helps to narrow the search. Additional search terms may be used to further limit the search results.

Additionally, the profile entered may also include dynamic advertising content. For example, if a business is not getting the number of hits expected, or other businesses within the same city and industry are growing at higher rates, the business may change their advertising, which may include audio and video, to better market their services to potential consumers. Additionally, the advertisement may be changed depending upon the city or state. A business having units in multiple cities may wish to advertise differently in one area of the country than in another area of the country. This dynamic advertising, collectively termed Homebrew Advertising™, may be used by the resource provider to better serve their community at the local level. Other content of the profile may be a URL to their business webpage, menus, price lists, etc. Once the resource provider enters their profile, at step 840, the profile is submitted and the user logs out at step 842. If the user wishes to edit their profile, for various reasons including the use of dynamic advertisement, at step 836, the user may edit and update their profile.

The portal may be available for searching by all users, including any user of the internet. At step 838, the user may enter search criteria such as location and industry, examine the search results at step 844, and download content at step 846. The user may also contact the service provider at step 848. If the user wishes to provide input about the content of the provider's profile, the user may submit content at step 850. The user may also examine another search result at step 852 or logout at step 854.

As with all resources, user input may be provided both on the resource provider side or the resource seeker side to refine the manner in which either may interface with the portal. At step 854, a user may input information regarding the profile of a particular resource provider or resource providers in general. For example, a resource provider may have a significant number of complaints on file in various consumer protection agencies. Users may, as part of the profile, input information regarding those complaints. Additionally, users may be using searches in an improper manner or need to change the interface in which to search to further refine the interface. At step 856, the user community may provide input to change the manner in which searches are conducted. A change may be to provide a linked list format instead of a free keyword format used on typical internet search engines.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is claimed:

1. A method of transacting resources, the method comprising:
establishing a forum to transfer resources from a resource provider to a resource seeker;
implementing a resource provider rule;
implementing a resource seeker rule;
identifying a user of the online forum as either a resource provider or a resource seeker; and
associating the resource provider rule with the user if the user is identified as a resource provider or associating the resource seeker rule if the user is identified as a resource seeker.

2. The method of claim 1, wherein the resource is a service, funding for a business, an investment, information relating to a topic, or the facilitation of the exchange of a resource.

3. The method of claim 1, wherein the forum is an internet website.

4. The method of claim 1, wherein the resource seeker rule comprises identification information, economic information, desired resource, and location.

5. The method of claim 1, wherein the resource provider rule comprises identification information, economic information, resources available, and location.

6. The method of claim 1, further comprising modifying the resource provider rule, wherein the modification is performed by a user of the portal.

7. The method of claim 1, wherein modifying the resource provider rule comprises providing information about the resource provider or creating a requirement for additional information.

8. The method of claim 1, further comprising modifying the resource seeker rule, wherein the modification is performed by a user of the portal.

9. The method of claim 8, wherein modifying the resource seeker rule comprises providing information about the resource seeker or creating a requirement for additional information.

10. A method of transacting a resource, the method comprising:
establishing a first platform to exchange information related to the resource;
facilitating the generation of a resource transaction from a resource provider to a resource seeker;
facilitating a first portion of the resource transaction in the first platform; and
facilitating a second portion of the resource transaction in a second platform.

11. The method of claim 10, wherein the resource is a service, funding for a business, an investment, information relating to a topic, or the facilitation of the exchange of a resource.

12. The method of claim 10, wherein the first platform is an internet website.

13. The method of claim 10, further comprising:
implementing a resource provider rule;
implementing a resource seeker rule;
identifying a user of the online forum as either a resource provider or a resource seeker; and
associating the resource provider rule with the user if the user is identified as a resource.

14. The method of claim 10, wherein the second platform is software package.

15. The method of claim 14, further comprising:
downloading the software package; and
installing the software package.

16. A computer-readable medium with a first set of computer-readable instructions stored thereon for transacting a resource, the first set of computer-readable instructions comprising instructions to:
establish a forum to exchange resources from a resource provider to a resource seeker;
implement a resource provider rule;
implement a resource seeker rule;
identify a user of the online forum as either a resource provider or a resource seeker; and
associate the resource provider rule with the user if the user is identified as a resource provider or associate the resource seeker rule if the user is identified as a resource seeker.

17. The computer-readable medium of claim 16, wherein the resource is a service, funding for a business, an investment, information relating to a topic, or the facilitation of the exchange of a resource.

18. The computer-readable medium of claim 16, further comprising instructions to transact a first portion of a resource transaction in the forum.

19. The computer-readable medium of claim 18, further comprising a second set of computer-readable instructions stored thereon, the second set of computer-readable instructions comprising instructions to transact a second portion of the resource transaction.

20. The computer-readable medium of claim 18, wherein the second set of computer-readable instructions is presented for download in the forum.
